(19) United States
(12) Patent Application Publication
(10) Pub. No.: US 2016/0057284 A1
(43) Pub. Date: Feb. 25, 2016

(54) METHOD AND SYSTEM FOR DETERMINING TELEPHONY SYSTEM RESPONSE

(71) Applicant: Verizon Patent and Licensing Inc., Arlington, VA (US)

(72) Inventors: Abhishek NAGPAL, Irving, TX (US); Manah M. KHALIL, Coppell, TX (US)

(21) Appl. No.: 14/465,256

(22) Filed: Aug. 21, 2014

(51) Int. Cl. H04M 3/523; H04M 3/51

(52) U.S. Cl. CPC H04M 3/5232; H04M 3/5175

(57) ABSTRACT

An approach for simulating a telephony system to enable the evaluation of rules employed by the system for routing inbound calls to representatives is described. A simulation manager receives call production data, representative production data, or a combination thereof as generated by a telephony system during a production run for directing one or more inbound calls to one or more representatives. The simulation manager also generates an expected call handling response of the telephony system during a subsequent production run due to (a) one or more subsequent inbound calls, (b) a change associated with the one or more representatives, (c) a change associated with the call handling rules, or (d) a combination thereof based on execution of a simulation of the execution of the telephony system.

### BACKGROUND INFORMATION

Network providers are continually challenged to deliver value and convenience to consumers by providing compelling services and advancing the underlying technologies. One area of interest has been the development of services and technologies for effectively placing incoming calls to an organization to a representative best suited to handle the call. By way of example, many organizations employ a telephony system for receiving, directing and placing calls to a representative that matches the department and/or need of the caller. The telephony system, which may include various hardware components (e.g., routers, voice response units), supports end-to-end call routing and placement based on a predetermined rule set.

Typically, the primary way to identify the effectiveness of a given rule set is to observe the actual handling of calls as they are placed onto the live telephony system. For example, the rules may be modified and then evaluated for effectiveness in terms of call placement speed or representative skill level by observing the response of the system to incoming calls. Unfortunately, the placement of calls onto the telephony system during a live production environment may itself impact the actual operation or service levels of the system. Moreover, this approach to evaluating the effectiveness of the rule set may not account for factors regarding the representatives that actually handle the incoming calls.

Based on the foregoing, there is a need for simulating a telephony system to enable the evaluation of rules employed by the system for routing inbound calls to representatives.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIGS. 1A and 1B are diagrams of a system for simulating a telephony system to enable the evaluation of rules employed by the system for assigning inbound calls to representatives, according to various embodiments;

FIGS. 1C and 1D are graphs depicting a penalty function to be applied based on the rules employed by the system for assigning inbound calls to representatives, according to various embodiments;

FIG. 2 is a diagram of a simulation manager, according to one embodiment;

FIGS. 3A-3D are flowcharts of processes for simulating a telephony system to enable the evaluation of rules employed by the system for assigning inbound calls to representatives, according to various embodiments;

FIG. 4A is a diagram of a user interface for simulating a telephony system to enable the evaluation of rules employed by the system for assigning inbound calls to representatives, according to one embodiment;

FIGS. 5A and 5B are diagrams of a queue and matrix generated by the simulation manager for assigning calls to representatives based on skill and availability, according to various embodiments;

FIG. 6 is a diagram of a user interface for indicating the assignment of calls to representatives based on their skill and availability, according to one embodiment;

FIG. 7 is a diagram of a computer system that can be used to implement various exemplary embodiments; and

FIG. 8 is a diagram of a chip set that can be used to implement an embodiment of the invention.

### DESCRIPTION OF THE PREFERRED EMBODIMENT

An apparatus, method and software for simulating a telephony system to enable the evaluation of rules employed by the system for routing inbound calls to representatives are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although the various exemplary embodiments are described with respect to calls exchanged over a telephony or wireless network, it is contemplated these embodiments have applicability to any data protocols, methodologies or systems for exchanging calls via a data network or service provider network (e.g., Internet). Also, as described herein with respect to the various exemplary embodiments, a call center may pertain to any agency, organization, group, business or the like that is dedicated to handling/responding to inbound calls placed onto a telephony or wireless network by one or more callers.

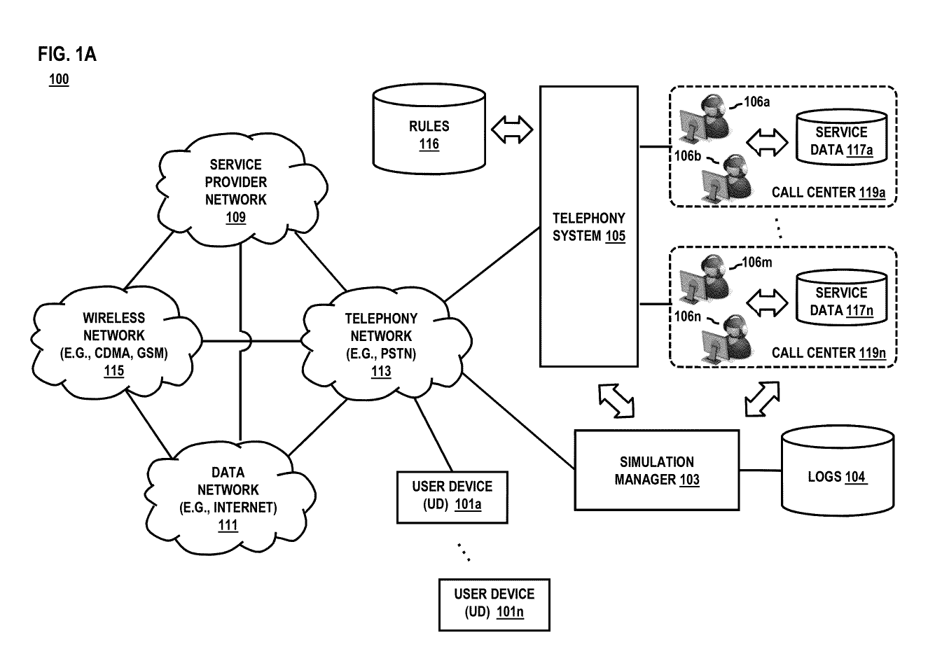

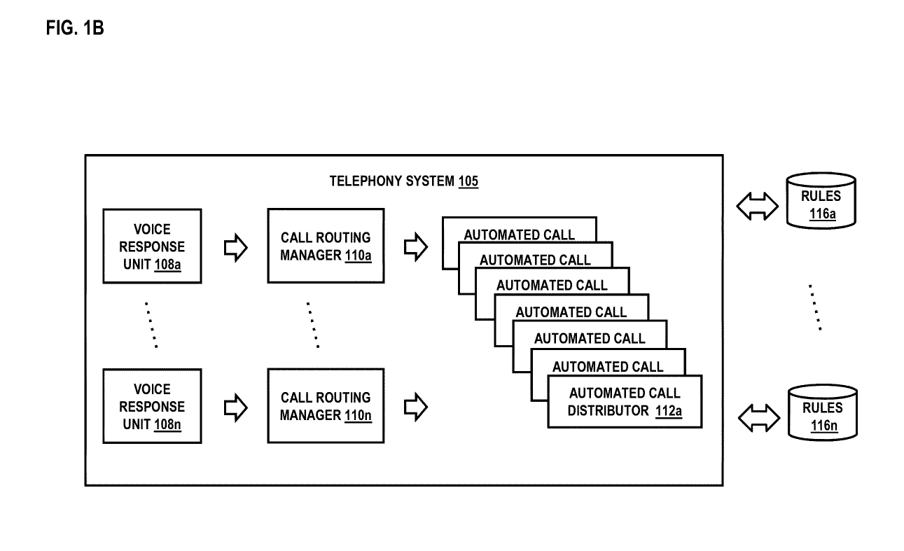

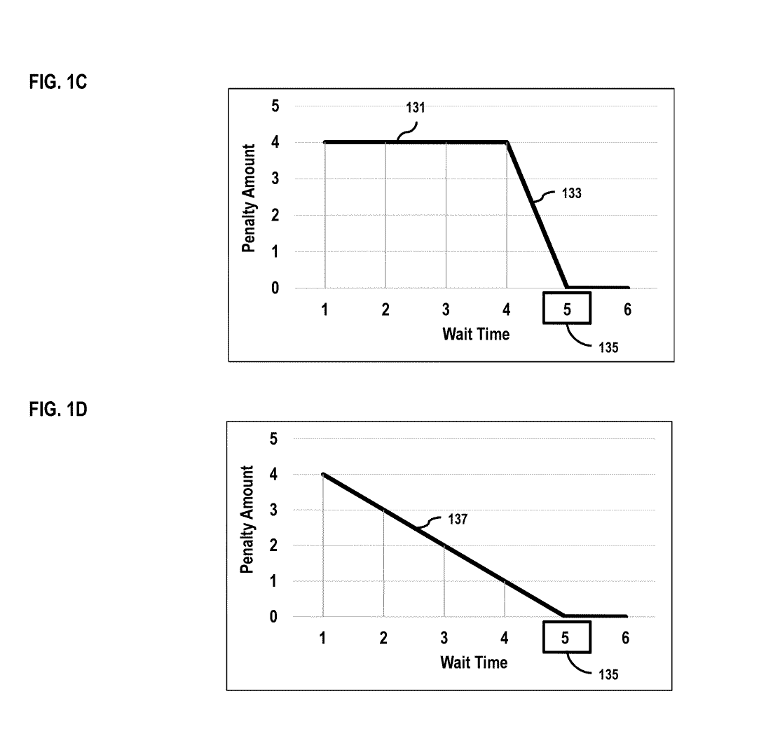

FIG. 1 is a diagram of a system for simulating a telephony system to enable the evaluation of rules employed by the system for routing inbound calls representatives, according to one embodiment. By way of example, system 100 is shown to include one or more user devices 101a-101n (e.g., mobile device, smart phone, netbook, laptop, set-top box, or any communications enabled computing device), referred to herein collectively as user devices 101, that are configured to place calls to a physical telephony system 101.

The telephony system 105 of system 100 may feature one or more hardware components for processing calls placed by the one or more user devices 101. Moreover, the telephony system 105 may be configured to a telephony network 113 or other network to facilitate the exchange of call data and signal information (e.g., Signaling System No. 7 (SS7) or integrated services digital network (ISDN)) data. It is also contemplated that the telephony system 105 may be a packetized voice system (e.g., Voice Over IP (Internet Protocol)), whereby appropriate IP telephony interfaces and gateways are employed. Thus, the telephony system 105 may be any infrastructure or network for facilitating the acceptance, analysis, queuing, routing and/or placement of calls.

As noted previously, many organizations employ telephony systems as a means of receiving, directing and placing inbound calls initiated by a caller to an appropriate representative within the organization. Depending on the arrangement of the organization, a representative may represent one or more departments or service types within the organization. This may include, for example, service, billing, sales, technical support, dispute resolution, account maintenance, activation, customer support, or any other department or service type. In addition, the representative may have a certain level of training, expertise or experience handling calls of various service types versus others. For example, a representative may have a primary skill of handling technical support related functions with a secondary skill of account maintenance. Thus, ideally, when a caller places a call, the telephony system should be configured to route the call to the representative that can best handle their needs.

To ensure proper handling calls from end-to-end, the telephony system may employ various network components for directing calls. This may include, for example, one or more voice response units (VRUs) for receiving caller specified input for identifying the purpose of the call, the intended destination of the caller, an action to be taken, or the like. The system may also include one or more call routing managers, which attempt to identify the caller based on known information conveyed during the call (e.g., automatic number identification (ANI), customer profile data) and/or the information provided to the VRU by the caller. The call routing manager may also operate in connection with an automated call distributor (ACD) for generating a number of queues for specifying the time, order and/or priority of incoming calls. The ACD then physically routes the calls as queued to a representative that is aligned with the service request.

Typically, the routing strategy performed by the telephony system is based on a rule-based set of instructions for dictating how incoming calls are to be handled within the system. The rule set may specify one or more processing schemes, conditions and variables for determining the best representative to respond to a given incoming call. The primary means of determining the effectiveness of a given rule set is to observe the actual handling of calls as they are placed onto the live telephony system. Per this approach, rules may be evaluated for effectiveness in terms of call placement speed, matching of the representative skill level to a specific service need, the length of time of the call, the amount of time the customer was placed on hold, etc. Unfortunately, because the calls must be placed during a live production environment, this action may itself impact the actual operation or service levels of the system. Moreover, this approach to evaluating the effectiveness of the rule set based only on the loading of calls to the system presents a limited view of system performance and may not account for factors regarding the representatives that receive the incoming calls.

To address this issue, system 100 presents a simulation manager 103 that simulates the execution of a telephony system 105 for processing one or more inbound calls. For the purpose of illustration herein, the processing of calls may include the receiving, analyzing, directing, routing and/or placement of calls to an endpoint or intended call recipient, handling of the call by the call recipient, or the like. The recipients of the calls placed onto the telephony system 105 may be representatives 106a-106n (referred to herein collectively as representatives 106) of a call center 119a-119n (referred to herein collectively as call centers 119). As such, the representatives 106 may be members or employees, third party resource providers or any other persons dedicated to handling inbound calls on behalf of a provider of the telephony system 105. The representatives 106 may also have access to service data 117, which may include caller profile information, call handling protocol and policy data, customer account data, etc. It is noted, therefore, that the telephony system 105 may be maintained by an organization, company or group and the call centers 119 may be distributed geographically, functionally or operationally for handling calls routed by the telephony system 105.

In one embodiment, the simulation manager 103 may be configured to operate as a testing system, evaluation tool, feedback mechanism or the like for depicting a response of the telephony system 105 to one or more inbound calls received from user devices 101. By way of example, the simulation manager may be implemented programmatically (e.g., as one or more software and/or firmware driven instructions) to model and/or mimic the response of a physical telephony system 105. As such, the simulation manager 103 may model and/or mimic the operation of the various hardware components of the telephony system 105 as they process inbound calls, as depicted in FIG. 1B. The components may include, for example, one or more voice response units (VRUs) 108a-108n and/or one or more and/or call routing managers 110a-110n. Hence, the simulation manager 103 may execute programmatic instructions for replicating: a call acceptance procedure, caller identification and/or authentication, service type/need identification based on caller provided input, segmenting and/or prioritizing of call types or callers, establishing of call queues based on rules 116 and parameters (e.g., time, date, caller location, caller identify), etc.

In addition, the simulation manager 103 also models and/or mimics execution of one or more automated call distributors (ACDs) 112a-112n of a telephony system 105. As such, the simulation manager 103 may execute programmatic instructions for replicating the analysis of calls placed in a call queue, the routing of calls in the queue to the one or more call centers 119 and/or representatives 106, updating of the queue based on the routing of calls, etc. In one embodiment, the simulation manager 103 may also enable the execution of one or more rules 116 for determining the assignment of calls to representatives 106, referred to herein also as call handling rules. The rules implemented by the simulation manager 103 may correspond to that of an algorithm performed by the ACDs 112a-112n (or in some cases the call routing managers 110a-110n) of the system 105. Under this scenario, the rules 116 may specify one or more processing schemes, conditions and variables for determining how calls are to be queued (e.g., establishment of virtual queues), routed through the telephony system 105 to a specific endpoint, department or call center 119 based on service type, assigned to a representative based on their availability, skill or proficiency, etc.

It is noted that the simulation manager 103 may simulate the execution of any other components of the system for processing and managing inbound calls (e.g., those not shown in FIG. 1B), including a public branch exchange (PBX) system, an automated attendant, a voice portal and various other routers, gateways and switching devices. Still further, the simulation manager 103 may support the execution of different call flows of the telephony system 105, including those based on different protocols and end-to-end call processing schemes. Hence, the simulation manager 103 may perform simulations independent of the specific component manufacturers, call flows or system configuration. The simulation manager 103 may replace a typical hardware/physical laboratory setup for evaluating call handling of the system 105 with a software-driven implementation.

In one embodiment, the simulation manager 103 executes the simulation per the call handling rules 116 based on the loading (inputting) of call production data and representative production data. In addition, profile information regarding the one or more representatives 106 may also be received as input for enabling the running of various simulations. The representative profile may specify the identifier, name, department, skill type and a skill level associated with a representative 106. In addition, the profile may indicate the defined schedule and availability of the representatives, including break periods, work hours, blackout/availability periods, etc. Still further, the profile may indicate historical statistics for representatives relating to their call handling over a period of time, including: a total number of calls handled, the average call duration, the average number of call transfers performed, the average number of simultaneous call occurrences, the average correlation between the service type and skill type, a percentage of time the representative fell below a predetermined call wait time threshold, etc. As such, the skill level of the representative may be based on these statistics and used in addition to availability information of a representative as a variable for executing a simulation.

By way of this approach, the rules 116 as established for the telephony system 105 are processed during a simulation based on two-way event generation, including: (a) the inputting and/or arrival of inbound calls and (b) availability and/or performance factors associated with the representatives that receive said inbound calls. This enables the simulation manager 103 to account for the skills of the representatives handling the calls relative to the service type identified by the caller. In addition, a skill level may be associated with a representative 106 (e.g., per the representative profile) for indicating a level of effectiveness or proficiency in handling a call pertaining to a specific service type. The profile may indicate a primary skill level, such as technical support, along with various other skill levels corresponding to other service types (e.g., account management, service activation).

In addition, representative schedule and availability information may be factored into a simulation in order to reproduce real-time scenarios as closely as possible. Rather than assume a fixed or standard period of availability, the simulation manager 103 may account for representative availability or lack thereof due to breaks, lunch periods, shift changes, off-times and peak periods within the context of the queuing, assigning and routing of calls to the representatives 106. Per this approach, the rules 116 executed by the telephony system 105 may also be evaluated as to their efficacy in enabling the assigning and routing of calls with respect to variations in the conditions or availability of representatives.

In one embodiment, the call production data may be provided as input to the simulation manager 103 in the form of call log data or call detail records generated over a period of time during a live production run of the telephony system 105. The live production run may include a period of time (e.g., time and/or date range) of actual operation of the telephony system 105 by the organization for handling inbound calls placed by user devices 101. By way of example, the call production data may include incoming and outgoing call timestamp information, caller identification information, ticket, queue or call sequence information, call duration information, call purpose or service type/need information, call dispatch or route information, etc. For the purpose of illustration herein, the call production data may be maintained by the telephony system 105 as historical data via a logs database 104 and accessed by the simulation manager 103 for executing a simulation.

In one embodiment, representative production data may also be provided to the simulation manager 103 as input. This data may also be maintained by the telephony system 105 via database 104 as representative log data, service log data or call response records generated over a period of time during a live production run. The representative production data may correspond to the actions executed by a representative 106 in response to the receipt of an inbound call to a queue. In addition, the representative production data may indicate the handling of a routed inbound call by a representative 106. By way of example, the representative production data may include representative identifier information, department information, region/location information, call pickup or call ending timestamp information, representative skill type information, call duration information, a number of hold times or call transfers performed, call wait time information, etc.

It is noted that the use of historical log data enables the simulation manager 103 to execute a more accurate simulation of the telephony system 105 response. In addition, simulation scenarios may be run for different time periods relative to a time of production of the logs 104. This includes, for example, the most recent production run of the telephony system 105 corresponding to the most recent version of the call handling rules 116. In one embodiment, the rules 116 implemented for execution of the most recent production run may be compared against a refined set of rules 116 as executed via the simulation manager 103. Per this approach, an evaluation may be performed to determine whether the refinements enhance the assigning and routing (output) of the telephony system 105.

In one embodiment, the simulation manager 103 enables the time of execution of the simulation to be controlled. This may include, for example, enabling a fast-forwarding of the execution of the simulation for a given date and/or time range of call production data or representative production data input. By way of example, the simulation manager 103 may be configured to initiate execution of the simulation based on the time of receipt of a first call to the system. Under this scenario, a production run for a telephony system 105 that begins at 6 pm may not experience a call event until 6:45 pm. Resultantly, the simulation manager 103 enables the simulation to be initialized for 6:45 pm, thus skipping approximately 45 minutes of non-event time. Thus, the time of the first call or even a first time of occurrence of a representative event may differ from the beginning time of the corresponding production logs.

In one embodiment, the simulation manager 103 may also apply a compression factor to the call production data and the representative production data for a given production run period for enabling fast-forwarding. By way of example, the call times as per the call production data and representative availability and call acceptance times, per the representative production data, are divided by the same factor to keep the respective times consistent. The simulation manager 103 may also add a standard deviation or variance factor to respective call wait times in order make the simulated results generated in a real-time manner. Per this execution, the simulation manager 103 may align the processing of the call production data and representative production data during the simulation according to the same internal processing rate or heartbeat. The rate of fast-forwarding may therefore be controlled by increasing or decreasing this internal heart beat accordingly.

It is noted that the simulation manager 103 may support the fast-forwarding of the simulation to a time corresponding to any call event or representative event that occurred within a specific production run range. As such, the entire production run period may be executed in this mode for enabling in a replay of the call routing and handling output of the system to be rendered quickly and effectively. Depending on the call volume and number of available representatives 106 for handling calls, fast-forwarding may enable the simulation manager 103 to execute a simulation in minutes rather than hours. In the case where updated rules 116 are being executed during the simulation, the call routing and assignment response (output) generated by the system 105 pursuant to the updated rules may be rendered expeditiously.

In one embodiment, the simulation manager 103 may render a user interface for enabling user execution of a simulation. The user interface may present various input selection options for the user for selecting specific call and/or representative production log files to provide as input to the simulation manager 103. Based on this input, the simulation manager 103 may parse the files and extract the necessary call production data and representative production data (e.g., timestamp information, call duration information, identifier information, representative skill information) for performing the simulation. In addition, the interface may enable a user to specify a rules base to be employed for execution of a simulation. As such, the user may perform the simulation based on a first and second set of rules for enabling comparative analysis of how calls are to be routed and assigned to the respective representatives by the telephony system 105.

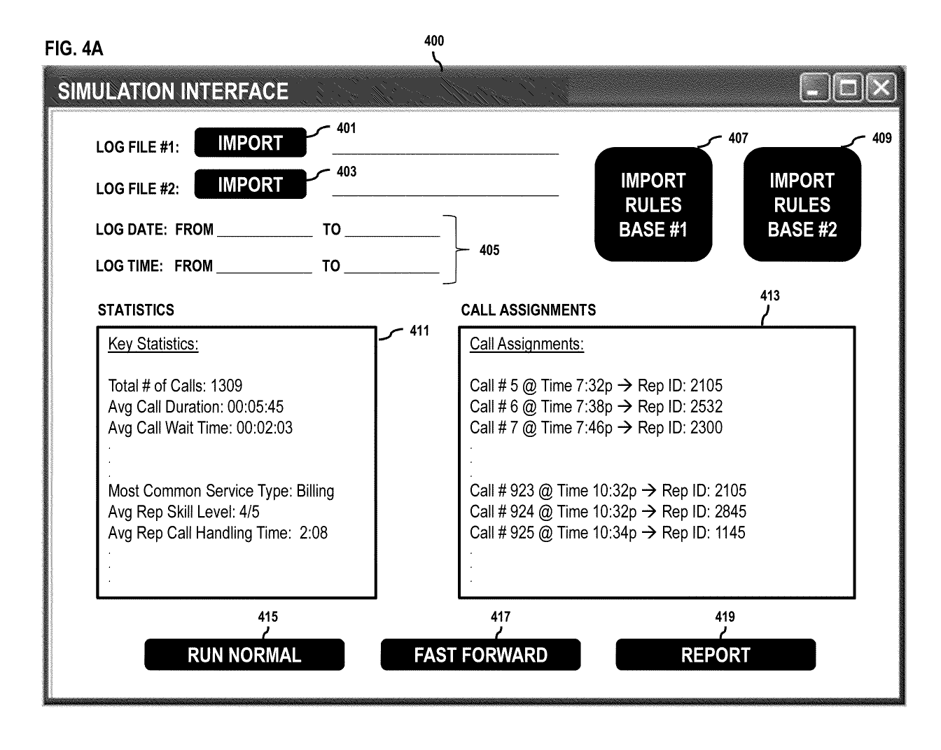

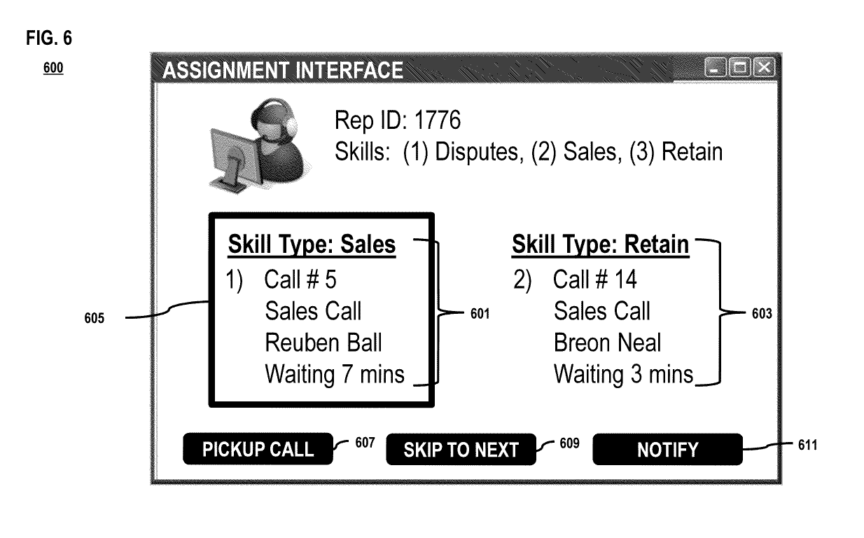

It is noted that the effectiveness of the rules may be evaluated on the basis of the skill of the representative 106 (e.g., a primary, secondary and tertiary skill and/or expertise), the proficiency of the representative 106 (e.g., a skill level or rating for a given area of specialty or training), the current and historic availability of the representative 106, the correlation between the service type specified by the caller and the skill type, wait times, etc. In one embodiment, the simulation manager 103 may also enable the presentment of a call assignment interface for use by a representative in determining an optimal call assignment. Per this interface, the representative may readily identify a specific call they should pick up as queued. Under this scenario, the simulation manager 103 can present the assignment relative to the specific representative and based on their availability as one or more instructions, recommendation or the like. More regarding the above described interface executions is presented later on herein with respect to FIGS. 4A and 6.

In one embodiment, the simulation manager 103 generates the one or more instructions, recommendations or values for specifying the assignment of inbound calls to one or more representatives 106. The assignment may be generated as an output resulting from the execution of the simulation per the specified rule base 116. For the purpose of illustration herein, an exemplary processing scheme for determining the assignment of calls based on the availability, skill or proficiency of representatives along with time information for the various calls is presented below. It is noted that the exemplary scheme, while executed programmatically via the simulation manager 103, may also correspond to the execution of the automated call distributors (ACDs) 112a-112n of the telephony system 105. Thus, it is contemplated in future embodiments that the below described processing scheme may be encoded for execution by an ACD or other component of the telephony system 105 accordingly.

In one embodiment, the simulation manager 103 generates a two-dimensional matrix for representing a wait time value (or wait time index) to be associated with a call of a given service type (e.g., billing, customer service, technical support as specified by a caller) relative to a given skill type of a representative available to handle the call. Under this scenario, the x-axis represents the service type (rows) while the y-axis represents the skill type (columns). Per the execution of the simulation manager 103 and/or the execution of an ACD operating per the same rules 116, each service type may be associated with a specific call queue. The queue therefore represents a list and/or sequence of calls associated with that service type that is to be handled by a representative, preferably with a matching skill (but not necessarily). The first call in the queue represents the call at the top of the queue (row) for a specific service type. As such, the matrix is initially generated based on the wait times of the first call in every queue and updated every time a queue has a new call on top of the queue.

By way of example, the wait time value to be associated with a call of a given service type (queue) is computed as follows:

1. A wait time threshold is established for representing a maximum wait time for any call regardless of service type. A key objective of a representative, once they are available, is to answer calls prior to reaching this threshold.

2. For a particular service type (row) in the matrix, the wait time value is computed relative to the current wait times for the call corresponding to that service type (e.g., as specified by the caller by way of the VRU 108). As such, the wait time value computed for column A (representative skill type), row A (call service/queue type) will always be 0. This corresponds to a scenario wherein a match between a call of a specific service type (e.g., Billing) that is within the queue and a representative having the same skill type (e.g., Billing) for handling such calls exists. In this case, the alignment of the call type/service type with the appropriate representative to service the need should correspond to zero wait time for assignment of the call to that representative. This computation, as computed for subsequent calls in a queue, results in the generation of a hollow matrix, wherein the main (matching) diagonal elements of the matrix equate to zero.

3. Every call within a queue of a specific service type (e.g., Sales) that does not match an equivalent skill type will have a number (a wait time value) assigned to it. This value is calculated as follows:
Wait time value=non-native skill call wait time minus native skill call wait time,
   wherein the native skill is equivalent (a match) to the call type specified in the queue and the non-native skill is different from the call type specified in the queue. By way of example, a representative skill type of billing is native to a call that is billing related and non-native to a sales related call.

4. If the wait time of the non-native skill is less than or equal to the wait time threshold, a wait time penalty is applied to the above calculated wait time value. In this case, the wait time threshold is further subtracted from that calculated wait time value. The calculation is as follows:
If non-native skill call wait time≦wait time threshold,
   Penalized wait time value=wait time value minus wait time threshold

It is noted that the penalty may be applied as a means of further delaying the handling of a particular call by a representative in the case where the call has not exceeded the threshold and the call type does not correspond to a native skill type of an available representative. Also, in one embodiment, the penalized wait time value may decrease as the wait duration approaches the wait threshold. The decrease may occur after a set period of enforcement of the penalized wait time followed by a sharp reduction of the wait time, i.e., as a step function. This is depicted, for example, in the graph of FIG. 1C, which shows a relationship between an applied penalty amount (y-axis) of 5minutes over a duration of time (x-axis). In this case, the penalty amount remains steady/fixed for the first 4 minutes as represented by line segment 131, then rapidly steps down as depicted by line segment 133 as the wait time approaches a predetermined 5 minute wait threshold 135.

Alternatively, as depicted for example purposes in FIG. 1D, the decrease may occur in a more linear fashion, i.e., as a negative slope function per line segment 137. Per this approach, the wait time penalty starts at 4 minutes, but is reduced in proportion to the amount of time elapsed until the penalty is zero up to the wait time threshold 135. In either the step or linear function approach, the reduction enables a caller that has been waiting longer after application of a penalty to be assigned a higher call handling priority as time progresses. While application of the penalty enables calls to be withheld from being handled when the current wait times and representative availability calls for such action, reduction of said penalty ensures that the calls are placed with a representative more readily and without significantly prolonging the caller wait time.

It is noted that the above described procedure may be performed periodically as a means of constantly refreshing the matrix and thus the call assignment scheme in response to the receipt of inbound calls. Alternatively, the refresh may be triggered by the availability of a representative for responding to a particular call type. In this manner, the call assignment procedure is multi-event driven from the perspective of inbound calls and/or representative availability for maximizing the placement of calls relative to the available representative pool.

In one embodiment, the output generated as a result of the simulation may be utilized for determining the assignment of calls in a queue. By way of example, the values calculated in the matrix per the above described processing scheme may indicate which call in a queue an available representative 106 is to handle. Under this scenario, the wait time values within the matrix serve as a recommendation; wherein the largest wait time value for a given skill type (column) of the matrix corresponds to the call type in the queue (row) to be handled.

Per this execution, when a representative 106 becomes available to handle calls, they may first refer to the column of the matrix corresponding to their primary skill (e.g., Sales) per a simulation interface of the simulation manager 103. Alternatively, the matrix results may be sent to the representative according to known data reporting methods or integrated for use in connection with a call center application or service portal. Based on this output, the representative may identify the largest wait time value within that column and note the corresponding row in order to identify the call service type they are to handle for their primary skill type. In the case where the representative's primary skill type is not specified within the matrix, the simulation manager 103 may present only the columns corresponding to another skill type (e.g., secondary or tertiary) of the representative. It is noted, therefore, that while only the skill types related to the representative are shown, any call type or queue may be presented to the representative regardless of their skill type. Furthermore, it is contemplated in certain embodiments that representatives with a higher skill level that become available at the same time for handling a queue matching their skill type may be prioritized higher for handling a call than a representative of a lesser skill level.

By way of the above described approaches, the simulation manager 103 may be employed as an offline tool for monitoring simulated activity of the telephony system 105 based on actual (historic) production data rendered as input. In addition, the output rendered by the simulation manager 103 may be utilized for evaluating the effectiveness of rules 116 established for impacting performance of the telephony system 105 in assigning calls to representatives 106 based on call type, representative availability information, etc. It is contemplated, in future embodiments, that the simulation manager 103 may be employed as an inline tool for dynamically adapting rules 116 during a production run of the telephony system 105. Per this approach, for example, the output rendered by a simulation may be fed to the telephony system for dynamically adapting the call assignments of representatives 106 along with the rules 116 for affecting subsequent telephony system 105 operation.

In certain embodiments, user devices 101a-101n, the simulation manager 103, the telephony system 105, the call centers 119 and other elements of system 100 may be configured to communicate via a telephony network 113. According to certain embodiments, one or more networks, such as service provider network 109, data network 111 and/or wireless network 115 can interact with the service provider network 109. Networks 109-115 may be any suitable wireline and/or wireless network, and be managed by one or more providers. For example, telephony network 113 may include a circuit-switched network, such as the public switched telephone network (PSTN), an integrated services digital network (ISDN), a private branch exchange (PBX), or other like network. Wireless network 115 may employ various technologies including, for example, code division multiple access (CDMA), long term evolution (LTE), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 111 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 109-115 may be completely or partially contained within one another, or may embody one or more of the aforementioned infrastructures. For instance, service provider network 109 may embody circuit-switched and/or packet-switched networks that include facilities to provide for transport of circuit-switched and/or packet-based communications. It is further contemplated that networks 109-115 may include components and facilities to provide for signaling and/or bearer communications between the various components or facilities of system 100. In this manner, networks 109-115 may embody or include portions of a signaling system 7 (SS7) network, Internet protocol multimedia subsystem (IMS), or other suitable infrastructure to support control and signaling functions.

According to exemplary embodiments, end user devices (not shown) may be utilized to communicate over system 100 and may include any customer premise equipment (CPE) capable of sending and/or receiving information over one or more of networks 109-115. For instance, voice terminal may be any suitable plain old telephone service (POTS) device, facsimile machine, etc., whereas mobile device (or terminal) may be any cellular phone, radiophone, satellite phone, smart phone, wireless phone, or any other suitable mobile device, such as a personal digital assistant (PDA), pocket personal computer, tablet, customized hardware, etc. Further, computing device may be any suitable computing device, such as a VoIP phone, skinny client control protocol (SCCP) phone, session initiation protocol (SIP) phone, IP phone, personal computer, softphone, workstation, terminal, server, etc.

It is noted, though not shown in the figure, that in certain embodiments user devices 101a-101n may be configured to establish peer-to-peer communication sessions with each other using a variety of technologies—near field communication (NFC), Bluetooth, ZigBee, infrared, etc. Also, connectivity can be provided via a wireless local area network (LAN). By way of example, a group of user devices 101a-101n may be configured to a common LAN so that each device can be uniquely identified via any suitable network addressing scheme. For example, the LAN may utilize the dynamic host configuration protocol (DHCP) to dynamically assign “private” DHCP internet protocol (IP) addresses to each user device 101, i.e., IP addresses that are accessible to devices connected to the service provider network 109 as facilitated via a router.

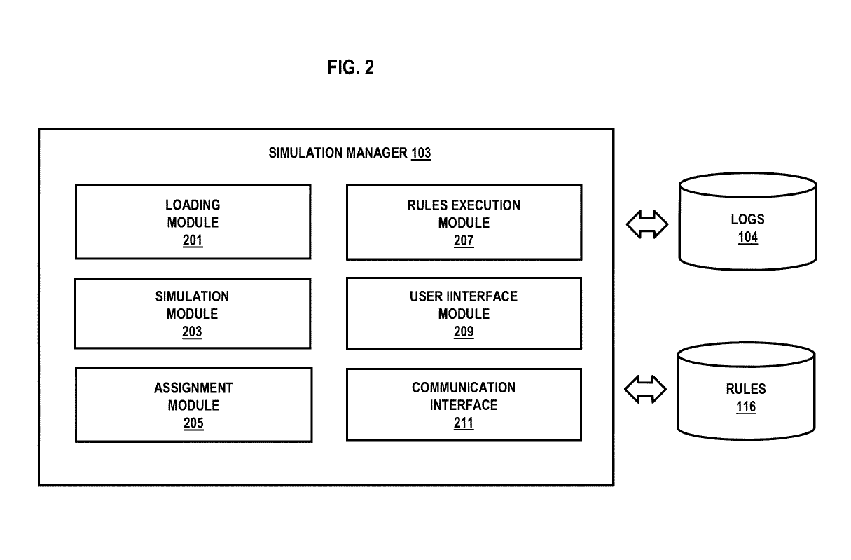

FIG. 2 is a diagram of a simulation manager, according to one embodiment. The simulation manager 103 includes various executable modules for performing one or more computing, data processing and telephony based instructions that in combination provide a means of simulating a telephony system to enable the evaluation of rules employed by the system for assigning inbound calls to representatives. Such modules can be implemented in hardware, firmware, software, or a combination thereof. By way of example, the simulation manager 103 may include a loading module 201, a simulation module 203, an assignment module 205, a rules execution module 207, a user interface module 209 and a communication interface 211.

In addition, the simulation manager 103 also accesses one or more log databases 104 for accessing call production data and representative production data from the telephony system 105 and/or call centers 119. Also, the simulation manager 103 may access a rule database 116a-116n for enabling the loading and execution of call handling rules. It is noted that modules 201-211 may access databases 104 and 116 for carrying out several of their distinct functions.

In one embodiment, the loading module 201 loads call production log data and representative production log data as maintained in databases 104 in response to a request to run a simulation. By way of example, the loading module 201 may load the data from the logs specified by a user to be loaded per a simulation user interface generated by the user interface module 209. Per this scenario, the loading of the logs may be based on a specified file name and well as a range or period of production of the telephony system 105 or call center 119.

It is noted that, depending on the arrangement of the organization the provides the telephony system 105, the call production logs and representative production logs may be acquired for loading independently from respective data sources (e.g., the call center and telephony system). Alternatively, the call production logs and representative production logs may be integrated, such that data regarding the actions and metrics of inbound calls to the system is included along with actions and metrics of the various representatives that service the calls. The loading module 201 may account for either implementation. Furthermore, the loading module 201 may parse the log data in order to provide the necessary input to the simulation module 203 for executing a simulation of the telephony system based on real-time gathered production data.

In one embodiment, the simulation module 203 models and/or mimics the operation of the various hardware components of the telephony system 105 as they process inbound calls. The components may include, for example, one or more voice response units (VRUs) 108a-108n and/or one or more and/or call routing managers 110a-110n. Hence, the simulation manager 103 may execute programmatic instructions for replicating: a call acceptance procedure, caller identification and/or authentication, service type/need identification based on caller provided input, segmenting and/or prioritizing of call types or callers, establishing of call queues based on rules 116 and parameters (e.g., time, date, caller location, caller identify), etc.

In addition, the simulation module 203 may operate in connection with a rules execution module 207 to model and/or mimic execution of one or more automated call distributors (ACDs) 112a-112n of a telephony system 105. As such, the simulation manager 103 may execute programmatic instructions for replicating the analysis of calls placed in a call queue, the routing of calls in the queue to the one or more call centers 119 and/or representatives 106, updating of the queue based on the routing of calls, etc.

In one embodiment, the rules execution module 207 executes of one or more rules 116 for determining the assignment of calls to representatives 106. The rules implemented by the simulation manager 103 may correspond to that of an algorithm performed by the ACDs 112a-112n (or in some cases the call routing managers 110a-110n) of the system 105. Under this scenario, the rules 116 may specify one or more processing schemes, conditions and variables for determining how calls are to be queued (e.g., establishment of virtual queues), routed through the telephony system 105 to a specific endpoint, department or call center 119 based on service type, assigned to a representative based on their availability, skill or proficiency, etc.

The rules execution module 207 may also enable the fast-forwarding of a simulation by the simulation module 203. By way of example, the module 207 may initiate execution of the simulation based on the time of receipt of a first call to the system. Thus, the time of the first call or even a first time of occurrence of a representative event may differ from the beginning time of the corresponding production logs. Also, the rules execution module 207 apply a compression factor to the call production data and the representative production data for a given production run period for enabling the fast-forwarding. The simulation manager 103 may also add a standard deviation or variance factor to respective call wait times in order make the simulated results generated in a real-time manner.

In one embodiment, the assignment module 205 operates in connection with the simulation module 203 to gather the output of the simulation for depicting the assignment of inbound calls to representatives. In addition, the assignment module 205 may operate in connection with the user interface module 209 to enable the presentment of the call assignments based on the simulation as a report or in a streamlined manner for view by a specific representative. In the latter scenario, the streamlined view may enable a specific representative having a specific set of skills to be presented with only the call types that are most relevant them (assuming the calls have not surpassed a system specified wait time threshold, in which case, any representative is required to handle said call).

In one embodiment, the user interface module 209 generates one or more graphic primitives for rendering an interface to the user. As such, the user interface module 209 may execute one or more application programming interfaces for supporting the presentment of data based on the operating system of the device accessing the simulation manager. In addition, the user interface module 209 may operate in connection with a communication interface 211 for enabling the formation of a session with a user of the simulation manager 103.

The above presented modules and components of the simulation manager 103 can be implemented in hardware, firmware, software, or a combination thereof. Though depicted as a separate entity in FIG. 1, it is contemplated that the simulation manager 103 may be implemented for direct operation by the telephony system 105. As such, the simulation manager 103 may generate direct signal inputs for influencing operation of the physical components of the telephony system—i.e., the various VRUs 108 or ACDs 112—for responding to inbound calls. Alternatively, the one or more modules 201-211 may be implemented for operation by the telephony system 105 as a platform or hosted solution, wherein the telephony system 105 calls upon the modules as needed via a network.

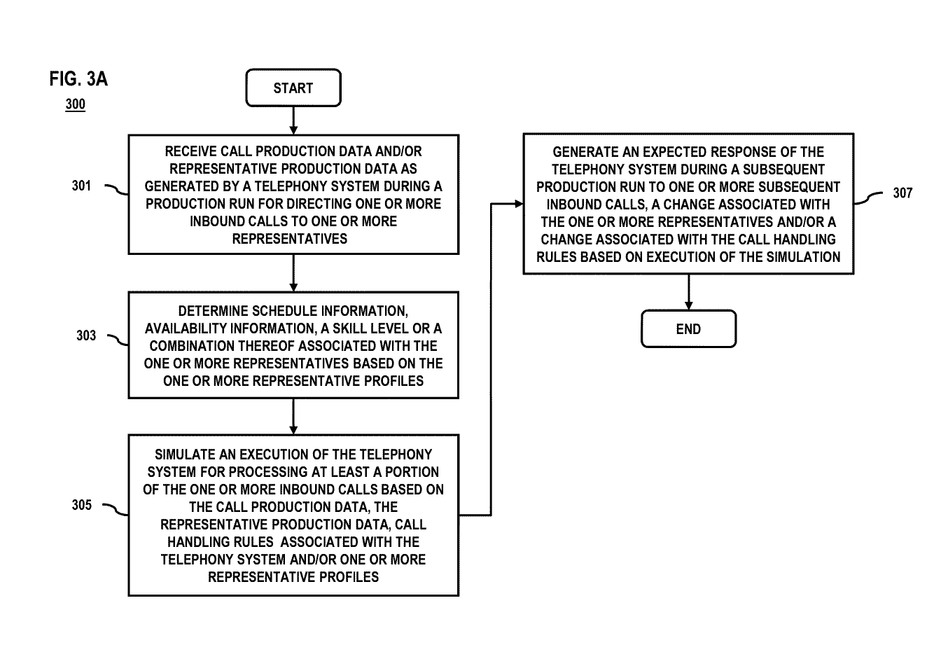

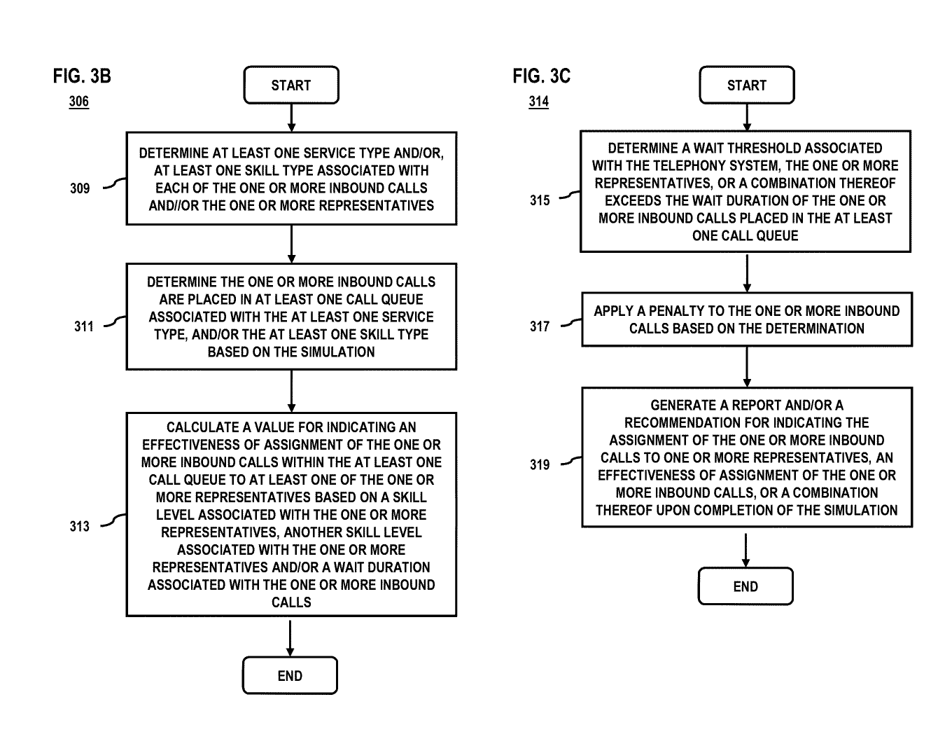

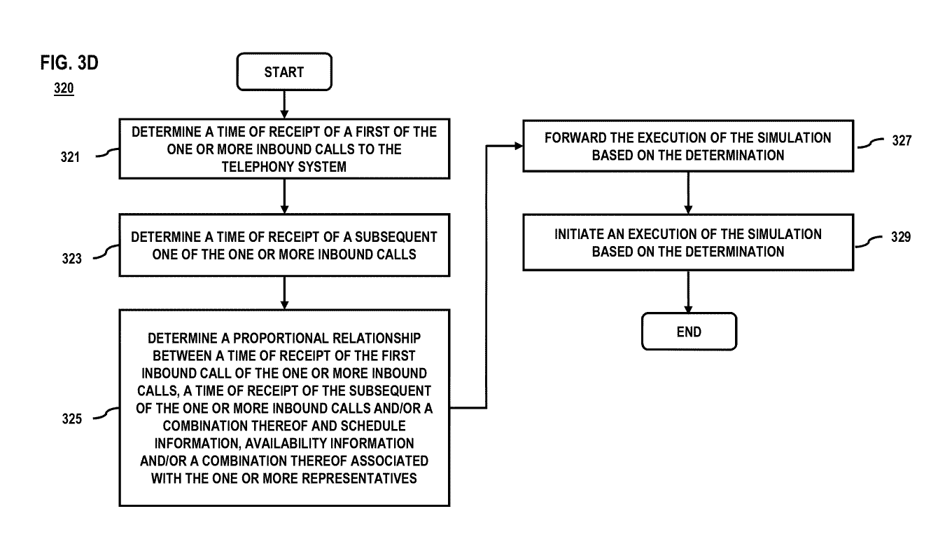

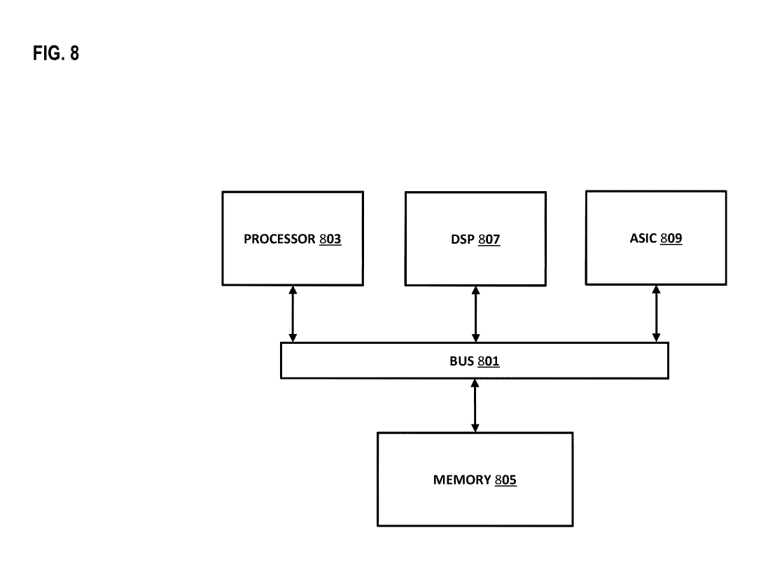

FIGS. 3A-3D are flowcharts of processes for simulating a telephony system to enable the evaluation of rules employed by the system for assigning inbound calls to representatives, according to various embodiments. In one embodiment, the simulation manager 103 performs processes 300, 306, 314 and 320 and is implemented in, for instance, a chip set including a processor and a memory device as shown in FIG. 8.

In step 301 of process 300 (FIG. 3A), the simulation manager 103 receives call production data, representative production data, or a combination thereof as generated by a telephony system during a production run for directing one or more inbound calls to one or more representatives. As noted previously, the call production data may include incoming and outgoing call timestamp information, caller identification information, ticket, queue or call sequence information, call duration information, call purpose or service type/need information, call dispatch or route information. Also, the representative production data may include, representative identifier information, department information, region/location information, call pickup or call ending timestamp information, representative skill type information, call duration information, a number of hold times or call transfers performed, call wait time information, etc. The production data may be extracted from one or more production logs maintained by the telephony system, one or more call centers or the like.

In another step 303, the simulation manager 103 determines schedule information, availability information, a skill level or a combination thereof associated with the one or more representatives based on the one or more representative profiles. As noted, the profiles may include metrics and details regarding current or historic availability and performance of the one or more representatives 106. Per step 305, the manager 103 simulates an execution of the telephony system for processing at least a portion of the one or more inbound calls based, at least in part, on the call production data, the representative production data, call handling rules associated with the telephony system, one or more representative profiles, or a combination thereof. As mentioned before, the call handling rules specify the call assignment scheme to be employed by the system 105, and particularly the ACD 112, relative to the identified service type/needs of the caller, the skill level of the available representatives, the current availability of the representatives, the current wait time of the various calls queued for assignment to the one or more representatives, etc.

Per step 307, the simulation manager 103 generates an expected call handling response of the telephony system during a subsequent production run due to (a) one or more subsequent inbound calls, (b) a change associated with the one or more representatives, (c) a change associated with the call handling rules, or (d) a combination thereof based on execution of the simulation. This corresponds to execution of the simulation as a tool for evaluating and/or testing a refined rule set for impacting the assigning of inbound calls to representatives 106. In addition, the impact of changes to representative availability due to various factors (e.g., call centers down due to inclement weather) may be tested and evaluated in advance without necessitating execution of this scenario via the live telephony system 105.

In step 309 of process 306 (FIG. 3B), the simulation manager 103 determines at least one service type, at least one skill type, or a combination thereof associated with each of the one or more inbound calls, the one or more representatives, or a combination thereof. As noted, the simulated execution of the telephony system, the expected call handling response of the telephony system, or a combination thereof is based at least in part on the determination. In another step 311, the manager 103 determines the one or more inbound calls are placed in at least one call queue associated with the at least one service type, the at least one skill type, or a combination thereof based on the simulation. In yet another step 313, the manager 103 calculates a value for indicating an effectiveness of assignment of the one or more inbound calls within the at least one call queue to at least one of the one or more representatives based, at least in part, on (a) a skill level associated with the one or more representatives, (b) another skill level associated with the one or more representatives, (c) a wait duration associated with the one or more inbound calls, or (d) a combination thereof.

It is noted that the calculation may correspond to the wait time values as generated per the earlier described matrix generation scheme. This calculation may be repeated periodically according to a predetermined refresh frequency or based on the availability information of the one or more representatives; thus accounting for the changing dynamic events that drive the performance of the telephony system 105.

In step 315 of process 314 (FIG. 3C), the simulation manager 103 determines a wait threshold associated with the telephony system, the one or more representatives, or a combination thereof exceeds the wait duration of the one or more inbound calls placed in the at least one call queue. In another step 317, the manager 103 applies a penalty to the one or more inbound calls based on the determination, wherein the penalty is an additional amount of wait time to be associated with the one or more inbound calls for calculating the value and the wait time decreases as the wait duration approaches the wait threshold. As noted previously, the reduction of the penalty corresponds to the functions presented with respect to FIGS. 1C and 1D, wherein calls placed in wait for a period of time may be given priority for being handled by representatives accordingly.

In step 319, the simulation manager 103 generates a report, a recommendation, or a combination thereof for indicating the assignment of the one or more inbound calls to one or more representatives, an effectiveness of assignment of the one or more inbound calls, or a combination thereof upon completion of the simulation. As noted previously, the report may correspond to the output response of the simulation for indicating the expected call handling response of the telephony system 105. As will be discussed further later on herein, the report may also correspond to the presentment of the assignment of the one or more inbound calls to a user interface of the one or more representatives, the provider of the telephony system 105, or a combination thereof.

In step 321 of process 320 (FIG. 3D), the simulation manager 103 determines a time of receipt of a first of the one or more inbound calls to the telephony system. As mentioned previously, the time of receipt may be the same or different than an initial time of recording of the call production data, the representative production data, or a combination thereof. In step 323, the manager 103 further determines a time of receipt of a subsequent one of the one or more inbound calls.

Per step 325, the simulation manager 103 determines a proportional relationship between a time of receipt of the first inbound call of the one or more inbound calls, a time of receipt of the subsequent of the one or more inbound calls, or a combination thereof and schedule information, availability information, or a combination thereof associated with the one or more representatives. In another step 327, the manager 103 forwards the execution of the simulation based on the determination. The forwarding of the execution of the simulation is based on the determination of the proportional relationship of step 325. Still further, in step 329, the manager 103 initiates the execution of the simulation based on the determination. It is noted that the fast-forwarding of the execution enables a simulation to be performed effectively in less time without compromising the integrity of the event triggers that account for telephony system performance, namely inbound call production data and representative production data.

FIG. 4A is a diagram of a user interface for simulating a telephony system to enable the evaluation of rules employed by the system for assigning inbound calls to representatives, according to one embodiment. For the purpose of illustration herein, the user interface 400 is presented from the perspective of a provider of the telephony system 105 for receiving and handling inbound calls. Under this scenario, the user interface 400 may be executed by the provider (e.g., a specific user that manages the system 105) for initiating execution of the simulation manager 103.

As shown in FIG. 4A, the user may be presented with one or more file selection options, including one or more IMPORT action buttons 401 and 403 for specifying a call production log and representative production log to be loaded by the simulation manager 103 as input. In addition, the user may be presented with data fields 405 for specifying a data and time range for importation of the production log files. Under this scenario, the user may control the amount of data to be imported and loaded into the system as well as the period of time for historical observation of calls and/or representative handling of said calls.

The user interface 400 also presents action buttons 407 and 409 for importing a first and second rule file respectively. The first rule file may correspond to an original rule set used during a historical production run of the telephony system 105 while the second may correspond to a test/refined/updated set of rules for enabling observation of the call assignments of the system. In this way, the first set of rules may be loaded to the simulation manager 103 for execution of the simulation while the second is queued for execution of a subsequent simulation run. It is noted that this approach enables the user to perform a before and after simulation for evaluating the response of the system to different processing schemes and/or variables. Similarly, the production log files may also be adapted in certain instances to observe execution of the simulation with respect to changes in call center availability, workforce capacity, skill level or skill type changes, or the like.

Once the logs and rules are loaded to the system, the user may select a RUN NORMAL action button 415 for executing the simulation for the specified period at a normal pace. As such, call or representative related events that trigger execution of the telephony system occur intermittently and/or upon arrival. Under this scenario, in the case of a twenty-four hour production run period, the simulation also takes twenty-four hours to perform. Alternatively, the user may select the FAST FORWARD action button 417 to control the rate of execution of the simulation, thereby bypassing any moments during the production run where calls or representative related events are not occurring. For the purpose of illustration, the user may select the FAST FORWARD action button 417 multiple times to affect the rate of execution of the simulation, to advance to the next call or representative event in the production run stream, etc.

Upon execution of the simulation, the user may also be presented with a statistics field 411 for presenting various data and metrics regarding the call activity, representative activity, or the like. This may include, for example, statistics for indicating the total number of calls processed, the average call duration and call wait time, the most common service type associated with incoming calls, the average skill level of the representatives, the average call handling time for the representatives, etc. It is noted that the statistics may be presented statically for indicating a final set of key metrics regarding the historical call set and rule set. Alternatively, the statistics field 411 may be dynamically updated for presenting the data with respect to the current point of execution of the log files.

The interface 400 may also include a call assignments field 413 for presenting a list of the incoming calls and their assignments relative to the selected rule set being executed. By way of example, the assignments field may specify the number and/or sequence of the call, the time of arrival of the call and the representative identifier that ultimately handled the call. It is contemplated that the user may further click and/or select a particular entry in the list 413 for obtaining more detail regarding the routing of the call and assignment thereof by the telephony system 105, the performance of the representative that handled the call, etc. A report may also be generated for indicating the results of the simulated production run of the telephony system upon completion of the simulation accordingly based on user selection of the REPORT action button 419. In the case where a second rule set is executed subsequent to execution the simulation based on the first, the report may include one or more comparative analysis results, variation metrics, discrepancy indicators, change effectiveness ratings, etc.

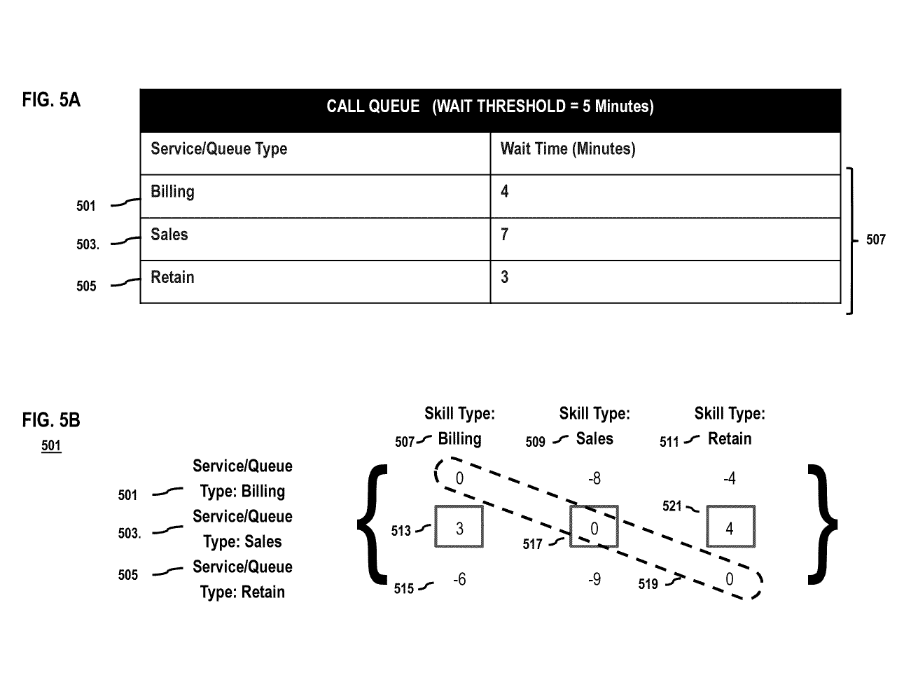

FIGS. 5A and 5B are diagrams of a queue and matrix generated by the simulation manager for assigning calls to representatives based on skill and availability, according to various embodiments. For the purpose of illustration herein, the diagrams are presented with respect to the matrix processing scheme described previously for determining optimal assigning of calls to available representatives. As noted, the processing scheme accounts for factors regarding the availability of the representative in addition to their relevant skill type and level thereof for handing an inbound call.

In FIG. 5A, different calls are maintained in different queues generated by the telephony system 105. The different queues correspond to the different service types associated with the respective calls, which in this example include a Billing queue 501 corresponding to a billing related call, a Sales queue 503 corresponding to a sales related call and a Retain queue 505 corresponding to a retention related call. In addition, each of the different calls have varying wait times 507, with the call for billing, sales and retention currently experiencing a 4, 7 and 3 minute wait time respectively. It is noted, in this example, that the wait threshold of the system is established at 5 minutes.

In FIG. 5B, a two-dimensional time/skill matrix 502 for assignment of calls in respective queues 501-505 to available reps is depicted. It is noted that the dimensions of the matrix may vary depending on the factors employed for evaluation of the response of the telephony system 106. In this case, the matrix 502 presents the different queues 501-505 (e.g., call service types) as rows of the matrix, while the different skill types 507-511 of the representatives are presented as columns. As noted previously, the elements of the matrix are computed based on rules to indicate a value representing a level of priority, recommendation, or the like for assignment of a particular call within a queue to a representative of a particular skill type. The higher the value of the element for a given skill type (column), the higher the recommendation of assignment of a call corresponding to that value or service type to the next available representative.

In this case, the value of the elements representing a match between a skill type and a service type for a call is zero, as shown per the diagonal formation 513 of the elements within the matrix 501. This corresponds to a scenario wherein a match between a call of a specific service type (e.g., Billing 501) that is within the queue and a representative having the same skill type (e.g., Billing 507) for handling such calls exists. In this case, the alignment of the call type/service type with the appropriate representative to service the need should correspond to zero wait time for assignment of the call to that representative.

Other elements of the matrix are calculated based on the following: Wait time value (value of an element of the matrix)=non-native skill call wait time minus native skill call wait time. Thus, in the case of element 515 of the matrix 501, the value of 3 is determined by subtracting the wait time of the call in the billing queue 501 (4 minutes), which is native to the billing skill type 507, from the wait time of the call in the sales queue 503 (7 minutes), which is not native to the billing skill type, i.e., 7−4=3. As another example, element 517 of the matrix 501 is determined by subtracting the wait time of the call in the billing queue 505 (4 minutes), which is native to the billing skill type 507, from the wait time of the call in the retain queue 505 (3 minutes), which is not native to the billing skill type. This results in a value of −1, i.e., 3−4=−1.

In this case, the retain queue 505, which is not native, is below the 5 minute threshold. As such, a penalty is applied to wait time value to determine a penalized wait time value, which is calculated as follows: Penalized wait time value=wait time value minus wait time threshold value. Per this calculation, the penalized wait time value of −6 is determined by subtracting the wait time threshold 5 from the wait time value of −1, i.e., −1−5=−6. Thus, the retain call in the queue 505 is forced by the telephony system to wait for a longer duration time for placement of a call to a representative.

This same calculation is performed to determine a value for each element of the matrix 501. Once the matrix is fully populated, the largest values for a given skill type may be identified for indicating which queue (service type) is to be given priority over another by a representative that is available to service the call. Hence, as soon as a representative with the skill type is available, this representative will be assigned the call in the queue having the highest value. In this example, element 513 is the highest value for a representative whose primary skill is billing 507, so the call in this queue 503 is placed with this representative immediately. Element 517 is the highest value for the skill type of sales 509, so the call in this queue 503 is placed with this representative immediately. Also, as element 521 is the highest value for the retain skill type (column) 511, the sales call 503 corresponding to this element is assigned to the next available representative of this skill type.

It is noted, in the case where the representative's primary skill type is not specified within the matrix, the simulation manager 103 may present only the columns corresponding to their secondary or tertiary skill type. For example, a representative whose primary skill type is disputes (not shown) may automatically be directed to their secondary skill of sales. Still further, the perspective of the representative may be limited to only those columns, or skill sets, that pertain to them. As such, as no dispute related calls are within the queue, if this representative is the first available with the skill type of sales, they are assigned the call corresponding to the sales queue 503 (based on the highest value of 0 for the sales column per element 517).

As another example, in the case where the above described representative whose secondary skill type is sales becomes available at the same time as a representative whose primary skill is sales, the call in the sales queue 503 is prioritized to the representative of the higher skill level. Resultantly, the representative whose secondary skill is sales is placed on hold until another sales call is placed in the queue or until a dispute related call corresponding to their primary skill arises. In the case of a dispute related inbound call, this results in a dispute queue being added to the matrix (not shown).

FIG. 6 is a diagram of a user interface for indicating the assignment of calls to representatives based on their skill and availability, according to one embodiment. Per this view, a representative may be presented with assignment recommendations in a streamlined fashion. By streamlined, it is meant that the level of detail shown with respect to FIGS. 5A and 5B is reduced to only that which is vital to the representative. Under this scenario, the streamlined view includes details 601 and 603 regarding a first prioritized call in a sales queue and a second prioritized call in the retain queue the representative is recommended to handle next based on the results of the matrix/processing scheme. In this case, the highest priority call is highlighted per box 605 for easy viewing by the representative. In addition, the representative may be presented with an a PICKUP CALL action button 607 for accepting the call and speaking with the caller on hold, a SKIP TO NEXT action button 609 for skipping to the next priority call 603 and a NOTIFY action button 611 for notifying the call center or telephony system that they are not available to handle the recommended calls (e.g., they have to leave to a meeting). In this way, the simulation manager may update the assignment scheme accordingly.

It is noted that the above described streamlined execution may correspond to dynamic usage of the simulation manager 103 for execution of different event driven scenarios. For example, while the output results may be based on the simulation, it is contemplated in certain instances that the assignment recommendations may be fed to the telephony system during a live production run for altering, adapting or overriding a current set of rules or mode of execution of the system to achieve a greater outcome.

The processes described herein for simulating a telephony system to enable the evaluation of rules employed by the system for assigning inbound calls to representatives may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

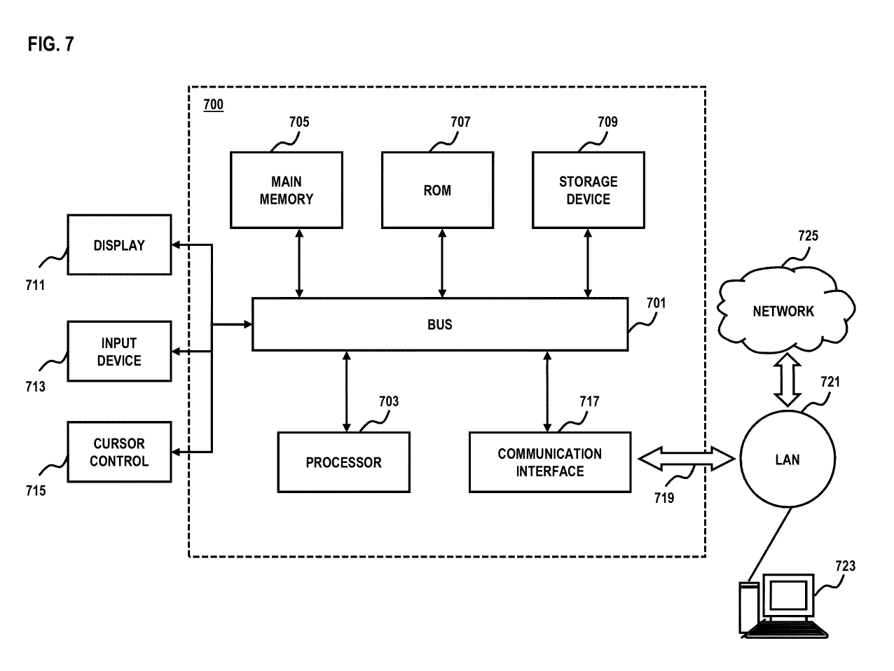

FIG. 7 is a diagram of a computer system that can be used to implement various exemplary embodiments. The computer system 700 includes a bus 701 or other communication mechanism for communicating information and one or more processors (of which one is shown) 703 coupled to the bus 701 for processing information. The computer system 700 also includes main memory 705, such as a random access memory (RAM) or other dynamic storage device, coupled to the bus 701 for storing information and instructions to be executed by the processor 703. Main memory 705 can also be used for storing temporary variables or other intermediate information during execution of instructions by the processor 703. The computer system 700 may further include a read only memory (ROM) 707 or other static storage device coupled to the bus 701 for storing static information and instructions for the processor 703. A storage device 709, such as a magnetic disk or optical disk, is coupled to the bus 701 for persistently storing information and instructions.

The computer system 700 may be coupled via the bus 701 to a display 711, such as a cathode ray tube (CRT), liquid crystal display, active matrix display, or plasma display, for displaying information to a computer user. An input device 713, such as a keyboard including alphanumeric and other keys, is coupled to the bus 701 for communicating information and command selections to the processor 703. Another type of user input device is a cursor control 715, such as a mouse, a trackball, or cursor direction keys, for communicating direction information and command selections to the processor 703 and for adjusting cursor movement on the display 711.

According to an embodiment of the invention, the processes described herein are performed by the computer system 700, in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry may be used in place of or in combination with software instructions to implement the embodiment of the invention. Thus, embodiments of the invention are not limited to any specific combination of hardware circuitry and software.

The computer system 700 also includes a communication interface 717 coupled to bus 701. The communication interface 717 provides a two-way data communication coupling to a network link 719 connected to a local network 721. For example, the communication interface 717 may be a digital subscriber line (DSL) card or modem, an integrated services digital network (ISDN) card, a cable modem, a telephone modem, or any other communication interface to provide a data communication connection to a corresponding type of communication line. As another example, communication interface 717 may be a local area network (LAN) card (e.g. for Ethernet™ or an Asynchronous Transfer Model (ATM) network) to provide a data communication connection to a compatible LAN. Wireless links can also be implemented. In any such implementation, communication interface 717 sends and receives electrical, electromagnetic, or optical signals that carry digital data streams representing various types of information. Further, the communication interface 717 can include peripheral interface devices, such as a Universal Serial Bus (USB) interface, a PCMCIA (Personal Computer Memory Card International Association) interface, etc. Although a single communication interface 717 is depicted in FIGS. 4A and 6, multiple communication interfaces can also be employed.

The network link 719 typically provides data communication through one or more networks to other data devices. For example, the network link 719 may provide a connection through local network 721 to a host computer 723, which has connectivity to a network 725 (e.g. a wide area network (WAN) or the global packet data communication network now commonly referred to as the “Internet”) or to data equipment operated by a service provider. The local network 721 and the network 725 both use electrical, electromagnetic, or optical signals to convey information and instructions. The signals through the various networks and the signals on the network link 719 and through the communication interface 717, which communicate digital data with the computer system 700, are exemplary forms of carrier waves bearing the information and instructions.

The computer system 700 can send messages and receive data, including program code, through the network(s), the network link 719, and the communication interface 717. In the Internet example, a server (not shown) might transmit requested code belonging to an application program for implementing an embodiment of the invention through the network 725, the local network 721 and the communication interface 717. The processor 703 may execute the transmitted code while being received and/or store the code in the storage device 709, or other non-volatile storage for later execution. In this manner, the computer system 700 may obtain application code in the form of a carrier wave.

The term “computer-readable medium” as used herein refers to any medium that participates in providing instructions to the processor 703 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 709. Volatile media include dynamic memory, such as main memory 705. Transmission media include coaxial cables, copper wire and fiber optics, including the wires that comprise the bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

FIG. 8 illustrates a chip set or chip 800 upon which an embodiment of the invention may be implemented. Chip set 800 is programmed to simulate a telephony system to enable the evaluation of rules employed by the system for assigning inbound calls to representatives as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of simulating a telephony system to enable the evaluation of rules employed by the system for assigning inbound calls to representatives.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to simulate a telephony system to enable the evaluation of rules employed by the system for assigning inbound calls to representatives. The memory 805 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
receiving call production data, representative production data, or a combination thereof as generated by a telephony system during a production run for directing one or more inbound calls to one or more representatives;
simulating an execution of the telephony system for processing at least a portion of the one or more inbound calls based, at least in part, on the call production data, the representative production data, call handling rules associated with the telephony system, one or more representative profiles, or a combination thereof; and
generating an expected call handling response of the telephony system during a subsequent production run due to (a) one or more subsequent inbound calls, (b) a change associated with the one or more representatives, (c) a change associated with the call handling rules, or (d) a combination thereof based on execution of the simulation.

2. A method of claim 1, further comprising:
determining schedule information, availability information, a skill level or a combination thereof associated with the one or more representatives based on the one or more representative profiles,
wherein the change associated with the one or more representatives is based on a change of the schedule information, availability information, skill level, or a combination thereof.

3. A method of claim 2, wherein the call handling rules specify how the one or more inbound calls are to be routed to the one or more representatives based on the determination.

4. A method of claim 1, further comprising:
determining at least one service type, at least one skill type, or a combination thereof associated with each of the one or more inbound calls, the one or more representatives, or a combination thereof,
wherein the simulated execution of the telephony system, the expected call handling response of the telephony system, or a combination thereof is based at least in part on the determination.

5. A method of claim 4, further comprising:
determining the one or more inbound calls are placed in at least one call queue associated with the at least one service type, the at least one skill type, or a combination thereof based on the simulation; and
calculating a value for indicating an effectiveness of assignment of the one or more inbound calls within the at least one call queue to at least one of the one or more representatives based, at least in part, on (a) a skill level associated with the one or more representatives, (b) another skill level associated with the one or more representatives, (c) a wait duration associated with the one or more inbound calls, or (d) a combination thereof,
wherein the calculation is repeated periodically, is based on the availability information of the one or more representatives, or a combination thereof.

6. A method of claim 5, further comprising:
determining a wait threshold associated with the telephony system, the one or more representatives, or a combination thereof exceeds the wait duration of the one or more inbound calls placed in the at least one call queue; and
applying a penalty to the one or more inbound calls based on the determination,
wherein the penalty is an additional amount of wait time to be associated with the one or more inbound calls for calculating the value and the wait time decreases as the wait duration approaches the wait threshold.

7. A method of claim 5, further comprising:
generating a report, a recommendation, or a combination thereof for indicating the assignment of the one or more inbound calls to one or more representatives, an effectiveness of assignment of the one or more inbound calls, or a combination thereof upon completion of the simulation,
wherein the expected call handling response of the telephony system is based on the report, the recommendation, or a combination thereof.

8. A method of claim 1, further comprising:
determining a time of receipt of a first of the one or more inbound calls to the telephony system; and
initiating the execution of the simulation based on the determination,
wherein the time of receipt is the same or different than an initial time of recording of the call production data, the representative production data, or a combination thereof.

9. A method of claim 8, further comprising:
determining a time of receipt of a subsequent one of the one or more inbound calls; and
forwarding the execution of the simulation based on the determination,
wherein the forwarding results in a lessened duration of time of execution of the simulation.

10. A method of claim 9, further comprising:
determining a proportional relationship between a time of receipt of the first inbound call of the portion of the one or more inbound calls, a time of receipt of the subsequent of the portion of the one or more inbound calls, or a combination thereof and schedule information, availability information, or a combination thereof associated with the one or more representatives,
wherein the forwarding of the execution of the simulation is based on the determination.

11. An apparatus comprising a processor configured to:
receive call production data, representative production data, or a combination thereof as generated by a telephony system during a production run for directing one or more inbound calls to one or more representatives;
simulate an execution of the telephony system for processing at least a portion of the one or more inbound calls based, at least in part, on the call production data, the representative production data, call handling rules associated with the telephony system, one or more representative profiles, or a combination thereof; and
generate an expected call handling response of the telephony system during a subsequent production run due to (a) one or more subsequent inbound calls, (b) a change associated with the one or more representatives, (c) a change associated with the call handling rules, or (d) a combination thereof based on execution of the simulation.

12. An apparatus of claim 11, wherein the processor is further configured to:
determine schedule information, availability information, a skill level or a combination thereof associated with the one or more representatives based on the one or more representative profiles,
wherein the change associated with the one or more representatives is based on a change of the schedule information, availability information, skill level, or a combination thereof.

13. An apparatus of claim 12, wherein the call handling rules specify how the one or more inbound calls are to be routed to the one or more representatives based on the determination.

14. An apparatus of claim 1, wherein the processor is further configured to:
determine at least one service type, at least one skill type, or a combination thereof associated with each of the one or more inbound calls, the one or more representatives, or a combination thereof,
wherein the simulated execution of the telephony system, the expected call handling response of the telephony system, or a combination thereof is based at least in part on the determination.

15. An apparatus of claim 14, wherein the processor is further configured to:
determine the one or more inbound calls are placed in at least one call queue associated with the at least one service type, the at least one skill type, or a combination thereof based on the simulation; and
calculate a value for indicating an effectiveness of assignment of the one or more inbound calls within the at least one call queue to at least one of the one or more representatives based, at least in part, on (a) a skill level associated with the one or more representatives, (b) another skill level associated with the one or more representatives, (c) a wait duration associated with the one or more inbound calls, or (d) a combination thereof,
wherein the calculation is repeated periodically, is based on the availability information of the one or more representatives, or a combination thereof.

16. An apparatus of claim 15, wherein the processor is further configured to:
determine a wait threshold associated with the telephony system, the one or more representatives, or a combination thereof exceeds the wait duration of the one or more inbound calls placed in the at least one call queue; and
apply a penalty to the one or more inbound calls based on the determination, wherein the penalty is an additional amount of wait time to be associated with the one or more inbound calls for calculating the value and the wait time decreases as the wait duration approaches the wait threshold.

17. An apparatus of claim 15, wherein the processor is further configured to:
generate a report, a recommendation, or a combination thereof for indicating the assignment of the one or more inbound calls to one or more representatives, an effectiveness of assignment of the one or more inbound calls, or a combination thereof upon completion of the simulation,
wherein the expected call handling response of the telephony system is based on the report, the recommendation, or a combination thereof.

18. A system comprising:
a telephony system configured for a production run; and
a platform configured to receive call production data, representative production data, or a combination thereof as generated by the telephony system during the production run for directing one or more inbound calls to one or more representatives; to simulate an execution of the telephony system for processing at least a portion of the one or more inbound calls based, at least in part, on the call production data, the representative production data, call handling rules associated with the telephony system, one or more representative profiles, or a combination thereof; and to generate an expected call handling response of the telephony system during a subsequent production run due to (a) one or more subsequent inbound calls, (b) a change associated with the one or more representatives, (c) a change associated with the call handling rules, or (d) a combination thereof based on execution of the simulation.

19. A system of claim 18, wherein the platform is further configured to determine schedule information, availability information, a skill level or a combination thereof associated with the one or more representatives based on the one or more representative profiles; and wherein the change associated with the one or more representatives is based on a change of the schedule information, availability information, skill level, or a combination thereof.

20. A system of claim 19, wherein the call handling rules specify how the one or more inbound calls are to be routed to the one or more representatives based on the determination.
